(19) United States
(12) Patent Application Publication
(10) Pub. No.: US 2020/0068689 A1
(43) Pub. Date: Feb. 27, 2020

(54) METHOD FOR CONTROLLING ILLUMINANCE OF INTELLIGENT DEVICE BASED ON CONTEXTUAL INFORMATION AND INTELLIGENT DEVICE

(71) Applicant: LG ELECTRONICS INC., Seoul (KR)

(72) Inventor: Hyounghwa YOON, Seoul (KR)

(73) Assignee: LG ELECTRONICS INC., Seoul (KR)

(21) Appl. No.: 16/669,090

(22) Filed: Oct. 30, 2019

(30) Foreign Application Priority Data
Sep. 3, 2019 (KR) 10-2019-0108660

(51) Int. Cl. H05B 37/02; H05B 33/08; G09G 3/34

(52) U.S. Cl. CPC H05B 37/0272; G09G 3/3406; H05B 37/0218; H05B 33/0854

(57) ABSTRACT

Provided are a method of controlling illuminance of an intelligent device based on situation information and the intelligent device. The intelligent device includes an illuminance sensor for sensing ambient illuminance thereof to generate an ambient illuminance value; a communication unit for receiving information related to an external illuminance value from an external device; and a processor for determining screen brightness of the intelligent device according to the ambient illuminance value and controlling screen brightness of the intelligent device based on information related to the external illuminance value. At least one of an intelligent device, a terminal, a server, and an IoT device may be connected to an Artificial Intelligence (AI) module, a drone (Unmanned Aerial Vehicle (UAV)), a robot, an augmented reality (AR) device, a virtual reality (VR) device, and a device related to a 5G service.

This application claims the priority benefit of Korean Patent Application No. 10-2019-0108660 filed on Sep. 3, 2019, which is incorporated herein by reference for all purposes as if fully set forth herein.

### BACKGROUND OF THE INVENTION

### Field of the Invention

The present disclosure relates to a method of controlling illuminance of an intelligent device based on situation information and the intelligent device, and more particularly, to a method of controlling illuminance of an intelligent device based on situation information and the intelligent device that can improve user convenience by controlling to automatically set appropriate brightness of a device according to a situation.

### Related Art

Recently, as the demand for convenient and safe residential life grows, the demand for smart home related products and services has increased and thus due to high added value, various fields of application, and widespread effects, concerns of companies such as mobile communication providers, home appliance manufacturers, and construction companies about smart home related products and services have increased.

However, many of currently developed IoT services provide a service based on simple wireless control or a stand product using an external IoT server and thus there is a problem that other home IoT devices are not linked to the IoT services.

### SUMMARY OF THE INVENTION

An object of the present disclosure is to address the above-described and other needs and/or problems.

The present disclosure further provides a method of controlling illuminance of an intelligent device based on situation information and the intelligent device that can improve user convenience by controlling to automatically set appropriate brightness of a device according to a situation.

In an aspect, a method of controlling illuminance of an intelligent device based on situation information includes obtaining an ambient illuminance value, which is a sensing value of ambient illuminance of the intelligent device; receiving information related to an external illuminance value from an external device; determining screen brightness of the intelligent device according to the ambient illuminance value; and controlling screen brightness of the intelligent device based on the information related to the external illuminance value.

The information related to the external illuminance value may include change time point information of external illuminance.

The method may further include obtaining the ambient illuminance value; distinguishing each location of the intelligent device; and generating a reference illuminance value of the ambient illuminance value according to each location of the intelligent device, wherein an indoor mode or an outdoor mode may be set based on the generated reference illuminance value.

The external device may include a lighting unit having at least one lighting; and a smart television, wherein the external illuminance value may include an illuminance value of a lighting sensed in the lighting unit; and a television illuminance value sensed in the smart television.

Screen brightness of the intelligent device may be controlled based on the external illuminance value while the intelligent device is switched from a turn-off state to a turn-on state, and screen brightness of the intelligent device may be controlled based on the ambient illuminance value while a turn-on state of the intelligent device is maintained.

The controlling of screen brightness may include extracting a feature value from information related to the external illuminance value; inputting the feature value to a pre-learned deep learning model; and obtaining information related to screen brightness of the intelligent device based on an output of the deep learning model.

When ambient illuminance of the intelligent device is changed while the intelligent device is being operated, the controlling of screen brightness may include controlling to gradually change screen brightness of the intelligent device.

The method may further include receiving, from a network, downlink control information (DCI) used for scheduling transmission of information related to the external illuminance value, wherein information related to the external illuminance value may be transmitted to the network based on the DCI.

The method may further include performing an initial access procedure with the network based on a synchronization signal block (SSB), wherein information related to the external illuminance value may be transmitted to the network through a physical uplink shared channel (PUSCH), and wherein DM-RSs of the PUSCH and the SSB may be QCL for QCL type D.

The method may further include controlling a communication unit to transmit information related to the external illuminance value to an AI processor included in the network; and controlling the communication unit to receive AI processed information from the AI processor, wherein the AI processed information may be information related to a screen brightness setting of the intelligent device.

In another aspect, an intelligent device includes an illuminance sensor for sensing ambient illuminance thereof to generate an ambient illuminance value; a communication unit for receiving information related to an external illuminance value from an external device; and a processor for determining screen brightness of the intelligent device according to the ambient illuminance value and controlling screen brightness of the intelligent device based on information related to the external illuminance value.

The information related to the external illuminance value may include change time point information of external illuminance.

The illuminance sensor may distinguish each location of the intelligent device under the control of the processor, generate a reference illuminance value of the ambient illuminance value according to each distinguished location of the intelligent device, and set an indoor mode or an outdoor mode based on the generated reference illuminance value.

The processor may control screen brightness of the intelligent device based on the ambient illuminance value while the intelligent device is switched from a turn-off state to a turn-on state and control screen brightness of the intelligent device based on the external illuminance value while a turn-on state of the intelligent device is maintained.

The external device may include a lighting unit having at least one lighting; and a smart television, wherein the external illuminance value may include an illuminance value of a lighting sensed in the lighting unit; and a television illuminance value sensed in the smart television.

The processor may extract a feature value from information related to the external illuminance value, input the feature value to a pre-learned deep learning model, and obtain information related to screen brightness of the intelligent device based on an output of the deep learning model.

When ambient illuminance of the intelligent device may be changed while the intelligent device is being operated, the processor may control to gradually change screen brightness of the intelligent device.

The processor may receive, from a network, downlink control information (DCI) used for scheduling transmission of information related to the external illuminance value, and wherein the processor may control to transmit information related to the external illuminance value to the network based on the DCI.

The processor may perform an initial access procedure with the network based on a synchronization signal block (SSB), wherein information related to the external illuminance value may be transmitted to the network through a physical uplink shared channel (PUSCH), and wherein DM-RSs of the PUSCH and the SSB may be QCL for QCL type D.

The processor may control a communication unit to transmit information related to the external illuminance value to an AI processor included in the network, and control the communication unit to receive AI processed information from the AI processor, wherein the AI processed information may be information related to screen brightness of the intelligent device.

Effects of an intelligent computing device, a device to control home appliance and an Intelligent home device control method according to an embodiment of the present disclosure will be described as follows.

According to the present disclosure, by controlling to automatically set appropriate brightness of a device according to a situation, user convenience can be improved.

According to the present disclosure, illuminance to enable a user to feel comfortable according to a surrounding situation through tracking of changes in illuminance, illuminance tracking through a cloud service controlling an IoT device, illuminance tracking according to an illuminometer for measuring illuminance, and illuminance tracking according to an actual use device can be adjusted quickly.

According to the present disclosure, by quickly adjusting illuminance to enable a user to feel comfortable according to a surrounding situation, user convenience can be improved.

According to the present disclosure, by tracking light on/off time change, appropriate brightness according to opening and closing of a pupil can be provided.

The effects of the present disclosure are not limited to the above-described effects and the other effects will be understood by those skilled in the art from the following description.

### BRIEF DESCRIPTION OF THE DRAWINGS

The accompanying drawings, which are included to provide a further understanding of the disclosure, illustrate embodiments of the disclosure and together with the description serve to explain the principle of the disclosure.

FIG. 1 is a block diagram illustrating a wireless communication system to which methods proposed in the present specification may be applied.

FIG. 2 is a diagram illustrating an example of a signal transmitting/receiving method in a wireless communication system.

FIG. 3 illustrates an example of a basic operation of a user terminal and a 5G network in a 5G communication system.

FIG. 4 is a diagram illustrating an illuminance control system of an intelligent device based on situation information according to an embodiment of the present disclosure.

FIG. 5 is a block diagram illustrating an intelligent device related to the present disclosure.

FIG. 6 is a block diagram illustrating an AI device according to an embodiment of the present disclosure.

FIG. 7 is a block diagram illustrating an intelligent device and an AI device related to the present disclosure.

FIG. 8 is a flowchart illustrating a method of controlling illuminance of an intelligent device based on situation information according to an embodiment of the present disclosure.

FIG. 9 is a flowchart illustrating in detail step of obtaining the ambient illuminance value of FIG. 8.

FIG. 10 is a flowchart illustrating an example of performing step of generating information related to screen brightness setting of the intelligent device of FIG. 8 through AI processing.

FIG. 11 is a flowchart illustrating an example of performing step of generating information related to screen brightness setting of the intelligent device of FIG. 8 through AI processing of a 5G network.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereinafter, 5G communication (5th generation mobile communication) required by an apparatus requiring AI processed information and/or an AI processor will be described through paragraphs A through G.

A. Example of Block Diagram of UE and 5G Network

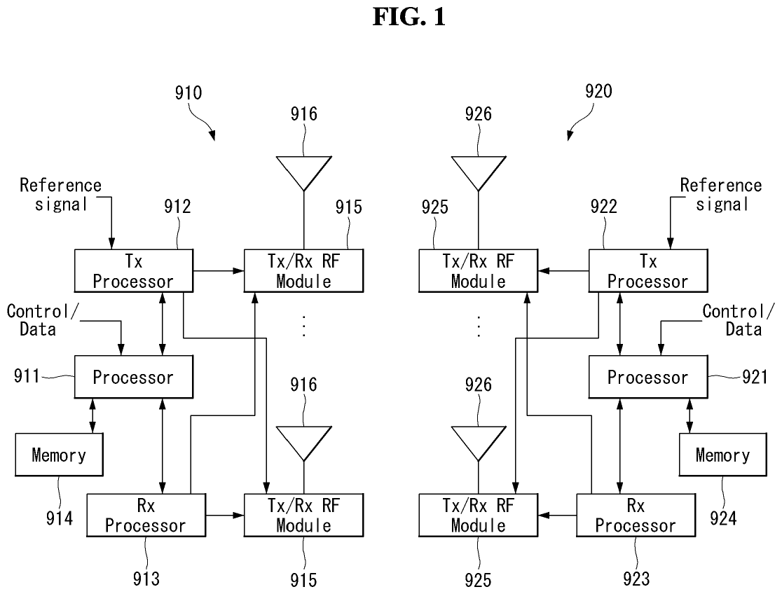

FIG. 1 is a block diagram of a wireless communication system to which methods proposed in the disclosure are applicable.

Referring to FIG. 1, a robot is defined as a first communication device 910, and a processor 911 can perform detailed operations of the robot.

A 5G network communicating with the robot is defined as a second communication device 920, and a processor 921 can perform detailed autonomous operations. Here, the 5G network may include another robot communicating with the robot.

The 5G network may be represented as the first communication device, and the robot may be represented as the second communication device.

For example, the first communication device or the second communication device may be a base station, a network node, a transmission terminal, a reception terminal, a wireless device, a wireless communication device, a robot, or the like.

For example, a terminal or user equipment (UE) may include a robot, a drone, a unmanned aerial vehicle (UAV), a cellular phone, a smart phone, a laptop computer, a digital broadcast terminal, a personal digital assistant (PDA), a portable multimedia player (PMP), a navigation device, a slate PC, a tablet PC, an ultrabook, a wearable device (e.g., a smart watch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

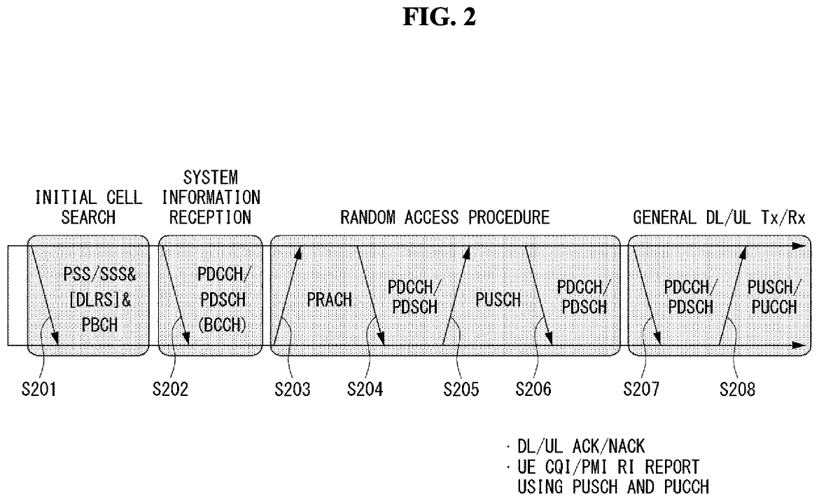

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent path loss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of SG Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.

A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.

The UE receives the signals on SSB resources from the BS on the basis of the CSI-SSB-ResourceSetList.

When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.

The UE receives an NZP CSI-RS resource set IE including an RRC parameter with respect to ‘repetition’ from a BS through RRC signaling. Here, the RRC parameter ‘repetition’ is set to ‘ON’.

The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.

The UE determines an RX beam thereof.

The UE skips a CSI report. That is, the UE can skip a CSI report when the RRC parameter ‘repetition’ is set to ‘ON’.

Next, the Tx beam determination procedure of a BS will be described.

A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.

The UE receives signals on resources in a CSI-RS resource set in which the RRC parameter ‘repetition’ is set to ‘OFF’ in different DL spatial domain transmission filters of the BS.

The UE selects (or determines) a best beam.

The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.

A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.

When SRS-SpatialRelationlnfo is set for SRS resources, the same beamforming as that used for the SSB, CSI-RS or SRS is applied. However, when SRS-SpatialRelationlnfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCelllD, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) returning from a first frequency resource to a second frequency resource is performed in a guard period and the specific information and the response to the specific information can be transmitted/received through a narrowband (e.g., 6 resource blocks (RBs) or 1 RB).

F. Basic Operation Between Robots Using 5G Communication

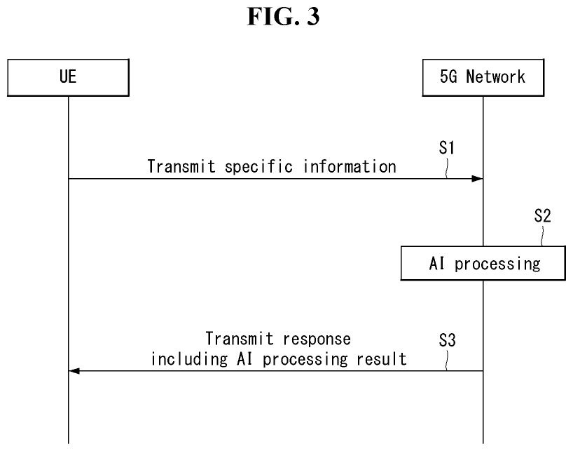

FIG. 3 shows an example of basic operations of a robot and a 5G network in a 5G communication system.

The robot transmits specific information to the 5G network (S1). The specific information may include autonomous driving related information. In addition, the 5G network can determine whether to remotely control the robot (S2). Here, the 5G network may include a server or a module which performs remote control related to autonomous driving. In addition, the 5G network can transmit information (or signal) related to remote control to the robot (S3).

G. Applied Operations Between Autonomous Robot and 5G Network in 5G Communication System

Hereinafter, the operation of a robot using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the robot performs an initial access procedure and a random access procedure with the 5G network prior to step S1 of FIG. 3 in order to transmit/receive signals, information and the like to/from the 5G network.

More specifically, the robot performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the robot receives a signal from the 5G network.

In addition, the robot performs a random access procedure with the 5G network for UL synchronization acquisition and/or UL transmission. The 5G network can transmit, to the robot, a UL grant for scheduling transmission of specific information. Accordingly, the robot transmits the specific information to the 5G network on the basis of the UL grant. In addition, the 5G network transmits, to the robot, a DL grant for scheduling transmission of 5G processing results with respect to the specific information. Accordingly, the 5G network can transmit, to the robot, information (or a signal) related to remote control on the basis of the DL grant.

Next, a basic procedure of an applied operation to which a method proposed by the present disclosure which will be described later and URLLC of 5G communication are applied will be described.

As described above, a robot can receive DownlinkPreemption IE from the 5G network after the robot performs an initial access procedure and/or a random access procedure with the 5G network. Then, the robot receives DCI format 2_1 including a preemption indication from the 5G network on the basis of DownlinkPreemption IE. The robot does not perform (or expect or assume) reception of eMBB data in resources (PRBs and/or OFDM symbols) indicated by the preemption indication. Thereafter, when the robot needs to transmit specific information, the robot can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the robot receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the robot transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The above-described 5G communication technology can be combined with methods proposed in the present disclosure which will be described later and applied or can complement the methods proposed in the present disclosure to make technical features of the methods concrete and clear.

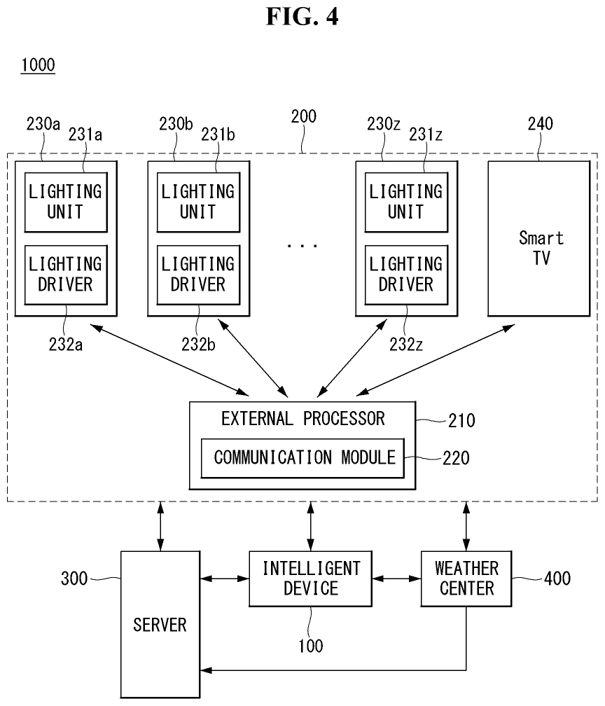

FIG. 4 is a diagram illustrating an illuminance control system of an intelligent device based on situation information according to an embodiment of the present disclosure.

Referring to FIG. 4, an illuminance control system 1000 may include a server 300, an intelligent device 100, an external device 200, and a weather center 400.

At least one of the server 300, the intelligent device 100, the external device 200, and the weather center 400 may be connected to a cloud network. The cloud network may mean a network that forms part of a cloud computing infrastructure or that exists within a cloud computing infrastructure. Here, the cloud network may be configured using a 3G network, a 4G network, a long term evolution (LTE) network, or a 5G network.

That is, the server 300, the intelligent device 100, the external device 200, and the weather center 400 constituting the illuminance control system 1000 may be connected to each other through the cloud network. In particular, the server 300, the intelligent device 100, the external device 200, and the weather center 400 may communicate with each other through a base station, but may directly communicate with each other without passing through a base station.

The server 300 may include a server 300 that performs an operation of big data. The server 300 may be referred to as an AI server 300. The server 300 may further include a server 300 that performs AI processing.

The server 300 may be connected to the intelligent device 100 or the external device 200 through the cloud network and assist at least a part of AI processing of the connected intelligent device 100 or external device 200.

In this case, the server 300 may learn an artificial neural network according to a machine learning algorithm instead of the intelligent device 100 or the external device 200, and directly store a learning model or transmit a learning model to the intelligent device 100 or the external device 200.

In this case, the server 300 may receive input data from the intelligent device 100 or the external device 200, infer a result value of the received input data using a learning model, and generate a response or a control command based on the inferred result value to transmit the response or the control command to the intelligent device 100 or the external device 200.

Alternatively, the intelligent device 100 or the external device 200 may infer a result value of the input data directly using a learning model and generate a response or a control command based on the inferred result value.

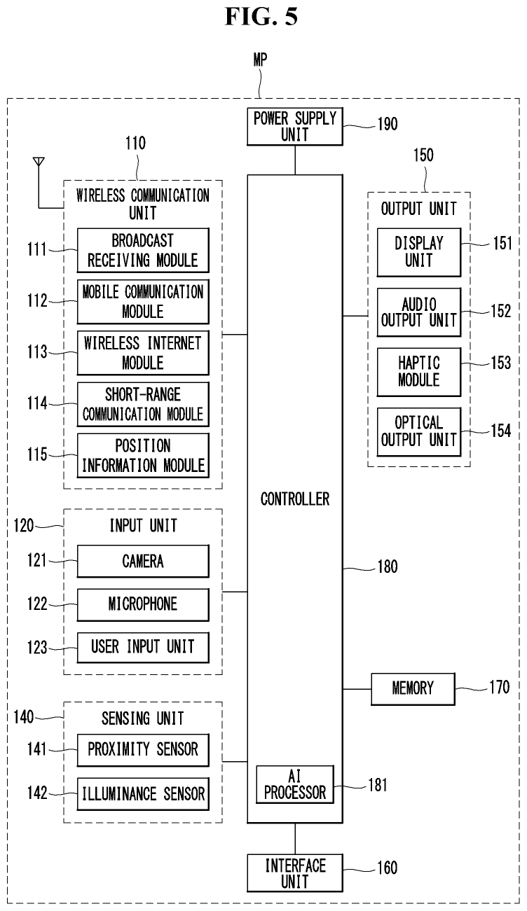

A detailed description of the intelligent device 100 will be described later in FIG. 5.

The external device 200 may be a lighting device or an electronic product disposed indoors such as a home or an office. The plurality of external devices 200 may be IoT devices.

The external device 200 may include an external processor 210, lighting devices 230a to 230z, a smart television 240, and the like. For example, the external processor 210 may receive external illuminance information related to lighting from the server 300, the intelligent device 100, or the weather center 400 and provide external illuminance information to the lighting devices 230a to 230z or the smart television 240, and receive internal illuminance information related to lighting from the lighting devices 230a to 230z or the smart television 240 to provide the internal illuminance information to the server 300, the intelligent device 100, or the weather center 400.

The external processor 210 may infer a result value of input data (external illuminance information or internal illuminance information) using a learning model, and generate a response or control command based on the inferred result value. The external processor 210 may include a communication module 220, and exchange information related to illuminance in real time with the server 300, the intelligent device 100, or the weather center 400 through the communication module 220. Here, it is illustrated that the communication module 220 is included in the external processor 210, but the present disclosure is not limited thereto and may be formed separately.

The lighting devices 230a to 230z may include lighting units 231a to 231z having at least one lighting and lighting drivers 232a-232z for driving the lighting units 231a to 231z. The lighting devices 230a to 230z may be electrically connected to the external processor 210 through a wireless or wired means.

The lighting drivers 232a to 232z may include an illuminance sensor (not shown). The lighting drivers 232a to 232z may drive to control brightness of the lighting units 231a to 231z based on the illuminance value sensed by the illuminance sensor. Further, the lighting drivers 232a to 232z may receive external illuminance information under the control of the external processor 210 to drive to control brightness of the lighting units 231a to 231z.

The lighting drivers 232a to 232z may provide internal illuminant information, which is an illuminance value sensed by an illuminance sensor in real time to the external processor 210.

The smart television 240 may include an operating system (OS) and a central processing unit (CPU), and have a computer function to be a television that can use not only broadcast viewing but also Internet search, games, applications, SNS, and the like. The smart television 240 may download and view various contents in real time from Internet, and watch a video without interruption while using Internet and watching television.

The smart television 240 may determine screen brightness thereof based on an illuminance value sensed by an illuminance sensor mounted in an external surface. Further, the smart television 240 may receive external illuminance information under the control of the external processor 210 to control screen brightness thereof. The smart television 240 may provide internal illuminance information, which is a sensing value sensed by the illuminance sensor in real time to the external processor 210.

FIG. 5 is a block diagram illustrating a mobile terminal related to the present disclosure.

Referring to FIG. 5, a mobile terminal MP may include a wireless communication unit 110, an input unit 120, a sensing unit 140, an output unit 150, an interface unit 160, a memory 170, a controller 180, and a power supply unit 190, and the like. It is understood that all the components illustrated in FIG. 5 is not requirements to implement the mobile terminal, and that more or fewer components may be alternatively implemented.

More specifically, the wireless communication unit 110 may include one or more modules which permit wireless communications between the mobile terminal MP and a wireless communication system, between the mobile terminal MP and another mobile terminal MP, or between the mobile terminal MP and an external server. Further, the wireless communication unit 110 may include one or more modules which connect the mobile terminal MP to one or more 5G networks.

The wireless communication unit 110 may include at least one of a broadcast receiving module 111, a mobile communication module 112, a wireless Internet module 113, a short-range communication module 114, or a location information module 115.

The input unit 120 may include a camera 121 which is one type of an image input unit for inputting an image signal, a microphone 122 which is one type of an audio input unit for inputting an audio signal, and a user input unit 123 (e.g., touch key, push key, etc.) for allowing a user to input information. Audio data or image data obtained by the input unit 120 may be analyzed and processed by user control commands.

The sensing unit 140 may include one or more sensors for sensing at least one of internal information of the mobile terminal, information about a surrounding environment of the mobile terminal, and user information. For example, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, an ultrasonic sensor, an optical sensor (e.g., camera 121), the microphone 122, a battery gauge, an environment sensor (e.g., a barometer, a hygrometer, a thermometer, a radiation detection sensor, a thermal sensor, a gas sensor, etc.), and a chemical sensor (e.g., an electronic nose, a health care sensor, a biometric sensor, etc.). The mobile terminal disclosed in the present specification may be configured to combine and utilize information obtained from two or more sensors of the sensing unit 140.

The output unit 150 may be configured to output various types of information, such as audio, video, tactile output, and the like. The output unit 150 may include at least one of a display unit 151, an audio output unit 152, a haptic module 153, or an optical output unit 154. The display unit 151 may have an inter-layered structure or an integrated structure with a touch sensor to implement a touch screen. The touch screen may provide an output interface between the mobile terminal MP and the user, as well as function as the user input unit 123 which provides an input interface between the mobile terminal MP and the user.

The interface unit 160 serves as an interface with various types of external devices that can be coupled to the mobile terminal MP. The interface unit 160 may include at least one of wired/wireless headset ports, external power supply ports, wired/wireless data ports, memory card ports, ports for connecting a device having an identification module, audio input/output (I/O) ports, video I/O ports, or earphone ports. The mobile terminal MP may perform assorted control functions associated with a connected external device, in response to the external device being connected to the interface unit 160.

The memory 170 stores data to support various functions of the mobile terminal MP. For instance, the memory 170 may be configured to store multiple application programs or applications executed in the mobile terminal MP, data or instructions for operations of the mobile terminal MP, and the like. At least some of these application programs may be downloaded from an external server via wireless communication. Other application programs may be installed within the mobile terminal MP at time of manufacturing or shipping, which is typically the case for basic functions (e.g., receiving a call, placing a call, receiving a message, sending a message, and the like) of the mobile terminal MP. The application programs may be stored in the memory 170, installed in the mobile terminal MP, and executed by the controller 180 to perform an operation (or function) for the mobile terminal MP.

The controller 180 typically functions to control overall operation of the mobile terminal MP, in addition to the operations associated with the application programs. The controller 180 may provide or process suitable information or functions appropriate for the user by processing signals, data, information and the like, which are input or output by the components mentioned above, or activating application programs stored in the memory 170.

The controller 180 may control at least some of the components illustrated in FIG. 5 in order to execute an application program that have been stored in the memory 170. In addition, the controller 180 may combine and operate at least two of the components included in the mobile terminal MP for the execution of the application program.

The power supply unit 190 is configured to receive external power or provide internal power and supply power to the respective components included in the mobile terminal MP under the control of the controller 180. The power supply unit 190 may include a battery, and the battery may be configured to be embedded in the device body, or configured to be detachable from the device body.

At least some of the above components may be combined with one another and operate, in order to implement an operation, a control, or a control method of a mobile terminal according to various embodiments described below. Further, the operation, the control, or the control method of the mobile terminal according to various embodiments may be implemented on the mobile terminal by an activation of at least one application program stored in the memory 170.

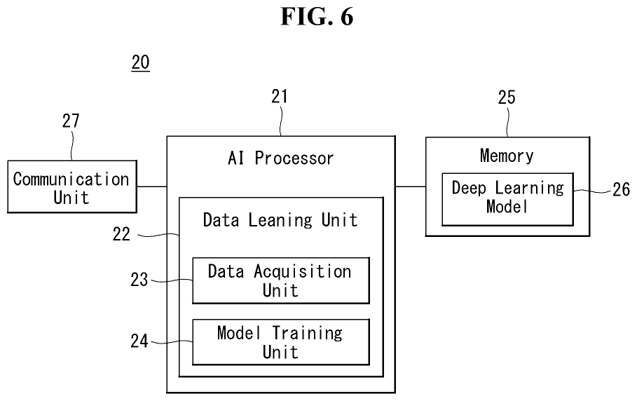

FIG. 6 is a block diagram of an AI device in accordance with the embodiment of the present disclosure.

The AI device 20 may include electronic equipment that includes an AI module to perform AI processing or a server that includes the AI module. Furthermore, the AI device 20 may be included in at least a portion of the intelligent device 100 illustrated in FIG. 5, and may be provided to perform at least some of the AI processing.

The AI processing may include all operations related to the function of the intelligent device 100 illustrated in FIG. 4. For example, the intelligent robot cleaner may AI-process sensing data or travel data to perform processing/determining and a control-signal generating operation. Furthermore, for example, the intelligent robot cleaner may AI-process data acquired through interaction with other electronic equipment provided in the intelligent robot cleaner to control sensing.

The AI device 20 may include an AI processor 21, a memory 25 and/or a communication unit 27.

The AI device 20 may be a computing device capable of learning a neural network, and may be implemented as various electronic devices such as a server, a desktop PC, a laptop PC ora tablet PC.

The AI processor 21 may learn the neural network using a program stored in the memory 25. Particularly, the AI processor 21 may learn the neural network for recognizing data related to the intelligent device 100. Here, the neural network for recognizing data related to the intelligent device 100 may be designed to simulate a human brain structure on the computer, and may include a plurality of network nodes having weights that simulate the neurons of the human neural network. The plurality of network nodes may exchange data according to the connecting relationship to simulate the synaptic action of neurons in which the neurons exchange signals through synapses. Here, the neural network may include the deep learning model developed from the neural network model. While the plurality of network nodes is located at different layers in the deep learning model, the nodes may exchange data according to the convolution connecting relationship. Examples of the neural network model include various deep learning techniques, such as a deep neural network (DNN), a convolution neural network (CNN), a recurrent neural network (RNN, Recurrent Boltzmann Machine), a restricted Boltzmann machine (RBM,), a deep belief network (DBN) or a deep Q-Network, and may be applied to fields such as computer vision, voice recognition, natural language processing, voice/signal processing or the like.

Meanwhile, the processor performing the above-described function may be a general-purpose processor (e.g. CPU), but may be an AI dedicated processor (e.g. GPU) for artificial intelligence learning.

The memory 25 may store various programs and data required to operate the AI device 20. The memory 25 may be implemented as a non-volatile memory, a volatile memory, a flash memory), a hard disk drive (HDD) or a solid state drive (SDD). The memory 25 may be accessed by the AI processor 21, and reading/writing/correcting/deleting/update of data by the AI processor 21 may be performed.

Furthermore, the memory 25 may store the neural network model (e.g. the deep learning model 26) generated through a learning algorithm for classifying/recognizing data in accordance with the embodiment of the present disclosure.

The AI processor 21 may include a data learning unit 22 which learns the neural network for data classification/recognition. The data learning unit 22 may learn a criterion about what learning data is used to determine the data classification/recognition and about how to classify and recognize data using the learning data. The data learning unit 22 may learn the deep learning model by acquiring the learning data that is used for learning and applying the acquired learning data to the deep learning model.

The data learning unit 22 may be made in the form of at least one hardware chip and may be mounted on the AI device 20. For example, the data learning unit 22 may be made in the form of a dedicated hardware chip for the artificial intelligence AI, and may be made as a portion of the general-purpose processor (CPU) or the graphic dedicated processor (GPU) to be mounted on the AI device 20. Furthermore, the data learning unit 22 may be implemented as a software module. When the data learning unit is implemented as the software module (or a program module including instructions), the software module may be stored in a non-transitory computer readable medium. In this case, at least one software module may be provided by an operating system (OS) or an application.

The data learning unit 22 may include the learning-data acquisition unit 23 and the model learning unit 24.

The learning-data acquisition unit 23 may acquire the learning data needed for the neural network model for classifying and recognizing the data. For example, the learning-data acquisition unit 23 may acquire vehicle data and/or sample data which are to be inputted into the neural network model, as the learning data.

The model learning unit 24 may learn to have a determination criterion about how the neural network model classifies predetermined data, using the acquired learning data. The model learning unit 24 may learn the neural network model, through supervised learning using at least some of the learning data as the determination criterion. Alternatively, the model learning unit 24 may learn the neural network model through unsupervised learning that finds the determination criterion, by learning by itself using the learning data without supervision. Furthermore, the model learning unit 24 may learn the neural network model through reinforcement learning using feedback on whether the result of situation determination according to the learning is correct. Furthermore, the model learning unit 24 may learn the neural network model using the learning algorithm including error back-propagation or gradient descent.

If the neural network model is learned, the model learning unit 24 may store the learned neural network model in the memory. The model learning unit 24 may store the learned neural network model in the memory of the server connected to the AI device 20 with a wire or wireless network.

The data learning unit 22 may further include a learning-data preprocessing unit (not shown) and a learning-data selection unit (not shown) to improve the analysis result of the recognition model or to save resources or time required for generating the recognition model.

The learning-data preprocessing unit may preprocess the acquired data so that the acquired data may be used for learning for situation determination. For example, the learning-data preprocessing unit may process the acquired data in a preset format so that the model learning unit 24 may use the acquired learning data for learning for image recognition.

Furthermore, the learning-data selection unit may select the data required for learning among the learning data acquired by the learning-data acquisition unit 23 or the learning data preprocessed in the preprocessing unit. The selected learning data may be provided to the model learning unit 24. For example, the learning-data selection unit may select only data on the object included in a specific region as the learning data, by detecting the specific region in the image acquired by the camera of the intelligent device 100.

Furthermore, the data learning unit 22 may further include a model evaluation unit (not shown) to improve the analysis result of the neural network model.

When the model evaluation unit inputs evaluated data into the neural network model and the analysis result outputted from the evaluated data does not satisfy a predetermined criterion, the model learning unit 22 may learn again. In this case, the evaluated data may be predefined data for evaluating the recognition model. By way of example, the model evaluation unit may evaluate that the predetermined criterion is not satisfied when the number or ratio of the evaluated data in which the analysis result is inaccurate among the analysis result of the learned recognition model for the evaluated data exceeds a preset threshold.

The communication unit 27 may transmit the AI processing result by the AI processor 21 to the external electronic equipment.

Here, the external electronic equipment may be defined as the intelligent device 100. Furthermore, the AI device 20 may be defined as another intelligent device 100 or a 5G network that communicates with the intelligent device 100. Meanwhile, the AI device 20 may be implemented by being functionally embedded in an autonomous driving module provided in the intelligent device 100. Furthermore, the 5G network may include a server or a module that performs related control of the intelligent device 100.

Although the AI device 20 illustrated in FIG. 6 is functionally divided into the AI processor 21, the memory 25, the communication unit 27 and the like, it is to be noted that the above-described components are integrated into one module, which is referred to as an AI module.

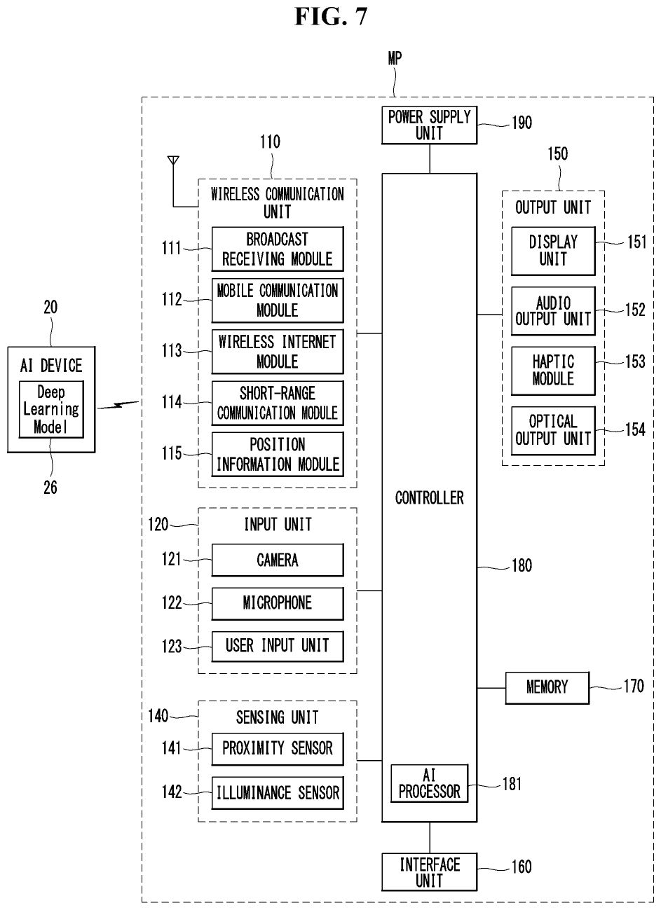

FIG. 7 is a block diagram illustrating an intelligent device and an AI device related to the present disclosure.

Because a description of the intelligent device 100 has been described in detail with reference to FIG. 5, a detailed description thereof will be omitted.

The intelligent device 100 may transmit data requiring AI processing to the AI device 20 through a communication unit 110, and the AI device 20 including a deep learning model 26 may transmit an AI processing result using the deep learning model 26 to the intelligent device 100. The AI device 20 may refer to the contents described with reference to FIG. 6.

A processor 180 may further include an AI processor 181.

Hereinafter, another electronic device and the AI processor 181 in the terminal connected to the interface unit will be described in more detail.

The intelligent device 100 may transmit an illuminance value sensed by an illuminance sensor 142 to the AI device 20 through the wireless communication unit 110, and the AI device 20 may transmit AI processing data generated by applying the transmitted illuminance value to the neural network model 26 to the intelligent device 100. The intelligent device 100 may determine optimal screen brightness based on the received AI processing data, and control screen brightness of the display 151 (see FIG. 5) using the optimal screen brightness.

The wireless communication unit 110 may exchange signals with an external device located outside the intelligent device 100. The wireless communication unit 110 may exchange signals with at least one of an infrastructure (e.g., server, broadcasting station), an IoT device, and another terminal. In order to perform communication, the wireless communication unit 110 may include at least one of a transmitting antenna, a receiving antenna, a radio frequency (RF) circuit capable of implementing various communication protocols, and an RF element.

The AI processor 181 may generate information related to optimal screen brightness setting of the intelligent device 100 using an illuminance value transmitted from the intelligent device 100, an illuminance value transmitted from the external device, and data on weather information from the weather center.

According to an embodiment of the present disclosure, the wireless communication unit 110 may obtain internal illuminance information, which is an illuminance value sensed by the external device 200. The wireless communication unit 110 may transfer the obtained internal illuminance information to the processor 180.

According to an embodiment of the present disclosure, the processor 180 may determine to set optimal screen brightness of the display 151 (see FIG. 5) based on internal illuminance information of the external device 200 transferred from the wireless communication unit 110, external illuminance information, which is an illuminance value sensed by the illuminance sensor of the intelligent device 100, and weather information.

Further, the processor 180 may transfer internal illuminance information of the external device 200, external illuminance information sensed by an illuminance sensor of the intelligent device, and weather information to the deep learning model 26 of the AI device 20 or the AI processor 181 in the processor 180 through the wireless communication unit 110. Thereafter, the processor 180 may obtain optimal screen brightness information determined by the deep learning model 26 of the AI device 20 or the AI processor 181 in the processor 180 through the wireless communication unit 110 and control screen brightness of the intelligent device 100 using the optimal screen brightness information.

In the above description, a schematic description of 5G communication necessary for implementing a method of controlling illuminance of an intelligent device based on situation information according to an embodiment of the present disclosure, performing AI processing by applying 5G communication, and transmitting and receiving AI processing results has been described.

Hereinafter, according to an embodiment of the present disclosure, a specific method of controlling screen brightness of an intelligent device based on internal illuminance information sensed by the external device 200, external illuminance information sensed by the intelligent device 100, and weather information will be described with reference to drawings.

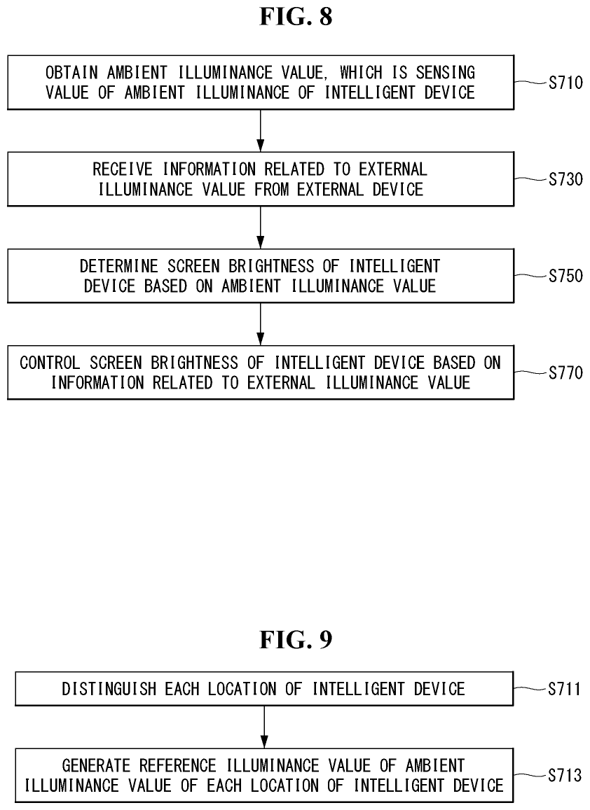

FIG. 8 is a flowchart illustrating a method of controlling illuminance of an intelligent device based on situation information according to an embodiment of the present disclosure.

As shown in FIG. 8, the intelligent device 100 may perform the method (S700) of controlling illuminance of the intelligent device based on the situation information of FIG. 8, and a detailed description thereof is as follows.

First, the intelligent device 100 may obtain an ambient illuminance value, which is a sensing value of ambient illuminance thereof (S710).

Here, ambient illuminance of the intelligent device 100 may be brightness of a surrounding environment sensed by an illuminance sensor mounted in the intelligent device 100. For example, the intelligent device 100 may sense brightness of a surrounding environment in real time using an illuminance sensor and obtain a sensed ambient illuminance value.

The intelligent device 100 may receive information related to an external illuminance value from an external device (S730). The external device may include a lighting unit having at least one lighting and a smart television. The information related to the external illuminance value may include an illuminance value of lighting sensed through an illuminance sensor mounted in the lighting unit, a television illuminance value sensed by the illuminance sensor mounted in the smart television, and information on a change time point of external illuminance. The change time point information of external illuminance may include daylight time information, user's home incoming and outgoing information, and lighting brightness timing information (including information in which the lighting devices 230a to 230z described in FIG. 4 are periodically turned on or turned off), and the like.

The intelligent device 100 may determine screen brightness thereof based on the ambient illuminance value (S750). The intelligent device 100 may determine or select screen brightness thereof based on an ambient illuminance value, which is sensing information sensed by the illuminance sensor mounted therein.

While the intelligent device is switched from a turn-off state to a turn-on state, screen brightness of the intelligent device may be determined or controlled based on an ambient illuminance value. Alternatively, while a turn-on state of the intelligent device is maintained, screen brightness of the intelligent device may be determined or controlled based on an external illuminance value.

Finally, the intelligent device 100 may control screen brightness thereof based on information related to an external illuminance value (S770).

Here, as ambient illuminance of the intelligent device 100 is changed, screen brightness of the intelligent device 100 is determined and then screen brightness of the intelligent device 100 may be readjusted based on information related to an external illuminance value.

For example, while the intelligent device 100 is operated by a user, when ambient illuminance of the intelligent device 100 is changed, the intelligent device 100 may determine screen brightness thereof according to the changed ambient illuminance and control to change screen brightness thereof based on information related to an external illuminance value.

The intelligent device 100 may gradually change screen brightness thereof until the user's eyes apply to ambient illuminance. While the intelligent device 100 is operated by a user, when ambient illuminance of the intelligent device 100 suddenly darkens, the intelligent device 100 may determine screen brightness thereof according to changed ambient illuminance and control to gradually darken screen brightness thereof based on the information related to the external illuminance value.

Alternatively, while the intelligent device 100 is operated by the user, when ambient illuminance of the intelligent device 100 suddenly becomes bright, the intelligent device 100 may determine screen brightness thereof according to changed ambient illuminance and control to gradually lighten screen brightness thereof based on information related to an external illuminance value.

FIG. 9 is a flowchart illustrating in detail step of obtaining the ambient light value of FIG. 8.

As illustrated in FIG. 9, the intelligent device 100 may distinguish each location thereof (S711).

The intelligent device 100 may distinguish a location thereof into indoor or outdoor. The present disclosure is not limited thereto, and when the intelligent device 100 is outdoor, the intelligent device 100 may distinguish in detail to day, night, or season.

Thereafter, the intelligent device 100 may generate a reference illuminance value of an ambient illuminance value according to each location thereof (S713).

The intelligent device 100 may differently generate a reference illuminance value of the ambient illuminance value according to indoor or outdoor. Accordingly, the intelligent device 100 may generate different reference illuminance values according to indoors or outdoors.

Further, when the intelligent device 100 determines that a current location thereof is outdoors, the intelligent device 100 may differently generate a reference illuminance value according to day and night. When it is determined that a current location of the intelligent device 100 is outdoors, the intelligent device 100 may differently generate a reference illuminance value according to seasons.

As described above, the intelligent device 100 may differently generate a reference illuminance value according to a location, thereby adjusting to screen brightness of the intelligent device in which the user feels comfortable based on the generated reference illuminance value.

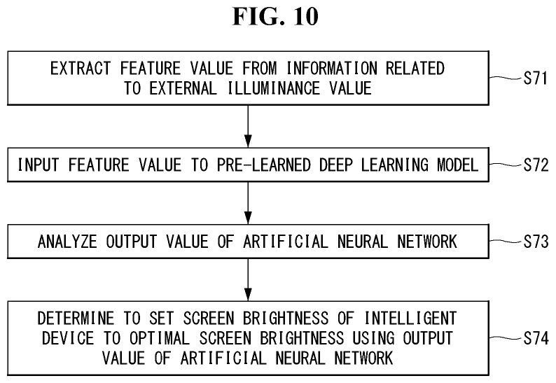

FIG. 10 is a flowchart illustrating an example of performing step of generating information related to screen brightness setting of the intelligent device of FIG. 8 through AI processing.

As shown in FIG. 10, the intelligent device 100 may extract a feature value from information related to an external illuminance value (S71).

For example, the intelligent device 100 may receive information related to the external illuminance value sensed in real time by the external device and extract a feature value from the transmitted external illuminance value. For example, the intelligent device 100 may extract feature values from weather information transmitted in real time through a weather sensor.

Thereafter, the intelligent device 100 may input the extracted feature value to a pre-learned artificial neural network (ANN) (S72).

Here, the artificial neural network may receive an input of a feature value extracted from information related to an external illuminance value and be learned in advance to generate information that may set screen brightness of the intelligent device as an output to optimal screen brightness.

Thereafter, the intelligent device 100 may analyze an output value of the artificial neural network (S73).

Finally, the intelligent device 100 may determine to set screen brightness thereof to optimal screen brightness using the output value of the artificial neural network (S74).

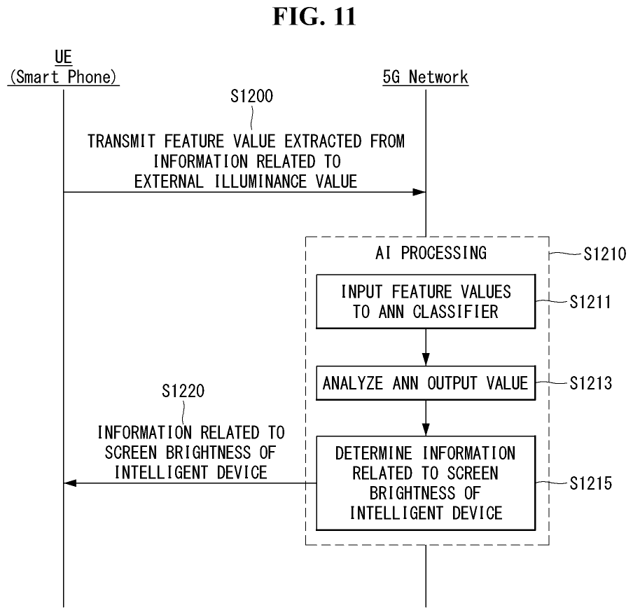

FIG. 11 is a flowchart illustrating an example of performing step of generating information related to screen brightness setting of the intelligent device of FIG. 8 through AI processing of a 5G network.

As shown in FIG. 11, the intelligent device 100 may transmit a feature value extracted from information related to an external illuminance value to the AI processor included in the 5G network through the wireless communication unit 110 (S1200). Further, the intelligent device 100 may control the wireless communication unit 110 to receive AI processed information from the AI processor.

The AI processed information may be information related to optimal screen brightness that enables a user to comfortably use screen brightness of the intelligent device.

In order to transmit a feature value of information related to the external illuminance value to the 5G network, the intelligent device 100 may perform an initial access procedure with the 5G network. The intelligent device 100 may perform an initial access procedure with the 5G network based on a synchronization signal block (SSB).

Further, the intelligent device 100 may receive, from a network, downlink control information (DCI) used for scheduling transmission of the feature value of information related to the external illuminance value through a wireless communication unit.

The processor 180 may transmit the feature value of information related to the external illuminance value to the network based on the DCI.

A feature value of information related to the external illuminance value may be transmitted to the network through a PUSCH, and DM-RSs of the PUSCH and the SSB may be QCL for QCL type D.

Here, the 5G network may include an AI processor or an AI system, and the AI system of the 5G network may perform AI processing based on the received feature value of information related to the external illuminance value (S1210).

Specifically, the AI system may input feature values received from the intelligent device 100 to the ANN classifier (S1211). The AI system may analyze an ANN output value (S1213) and determine information related to the external illuminance value from the ANN output value (S1215).

The 5G network may transmit information related to the external illuminance value determined in the AI system to the intelligent device 100 through the wireless communication unit (S1220).

The intelligent device 100 may transmit only information related to the external illuminance value to the 5G network and extract a feature value corresponding to information related to an external illuminance value to be used as an input of an artificial neural network for determining a screen brightness setting of the intelligent device from information related to the external illuminance value in the AI system included in the 5G network.

The present disclosure described above may be implemented using a computer-readable medium with programs recorded thereon for execution by a processor to perform various methods presented herein. The computer-readable medium includes all kinds of recording devices capable of storing data that is readable by a computer system. Examples of the computer-readable mediums include hard disk drive (HDD), solid state disk (SSD), silicon disk drive (SDD), ROM, RAM, CD-ROM, a magnetic tape, a floppy disk, an optical data storage device, the other types of storage mediums presented herein, and combinations thereof. If desired, the computer-readable medium may be realized in the form of a carrier wave (e.g., transmission over Internet). Thus, the foregoing description is merely an example and is not to be considered as limiting the present disclosure. The scope of the present disclosure should be determined by rational interpretation of the appended claims, and all changes within the equivalent range of the present disclosure are included in the scope of the present disclosure.

1. A method of controlling illuminance of an intelligent device, the method comprising:
obtaining an ambient illuminance value associated with the intelligent device based on a sensing of an ambient illuminance of the intelligent device;
receiving, by a wireless communication unit of the intelligent device, information related to an external illuminance from at least one external device;
selecting, by a controller of the intelligent device, a screen brightness of the intelligent device according to the ambient illuminance value; and
adjusting, by the controller, the screen brightness of the intelligent device based on the information related to the external illuminance.

2. The method of claim 1, wherein the information related to the external illuminance comprises at least one of the following:
change time point information of external illuminance associated with the intelligent device,
lighting illumination information associated with at least one light unit providing illumination in an environment of the intelligent device, and
television illumination information associated with a smart television provided in the environment of the intelligent device.

3. The method of claim 2, further comprising:
obtaining, by a sensor of the intelligent device, the ambient illuminance value;
determining a plurality of locations of the intelligent device; and
generating a reference illuminance value of the ambient illuminance value according to each of the plurality of locations of the intelligent device,
wherein an indoor mode or an outdoor mode for the intelligent device is set based on the generated reference illuminance value.

4. The method of claim 1, wherein the at least one external device comprises at least one of the following:
a lighting device having at least one lighting unit; and
a smart television, and
wherein a value of the external illuminance comprises at least one of the following:
an illuminance value of a lighting sensed in the lighting device; and
a television illuminance value sensed in the smart television.

5. The method of claim 4, wherein the screen brightness of the intelligent device is controlled based on the ambient illuminance value while the intelligent device is switched from a turn-off state to a turn-on state, and
wherein the screen brightness of the intelligent device is controlled based on the value of the external illuminance while the turn-on state of the intelligent device is maintained.

6. The method of claim 1, wherein the adjusting the screen brightness of the intelligent device comprises:
extracting a feature value from the information related to the external illuminance;
inputting the feature value to a pre-learned deep learning model; and
obtaining information related to the screen brightness of the intelligent device based on an output of the deep learning model having the feature value input thereto.

7. The method of claim 6, wherein the adjusting the screen brightness of the intelligent device comprises:
gradually changing the screen brightness of the intelligent device, when the ambient illuminance of the intelligent device is changed while the intelligent device is being operated.

8. The method of claim 1, further comprising: receiving, by the wireless communication unit from a network, downlink control information (DCI) used for scheduling transmission of the information related to the external illuminance,
wherein the information related to the external illuminance is transmitted to the network based on the DC1.

9. The method of claim 8, further comprising:
performing an initial access procedure with the network based on a synchronization signal block (SSB),
wherein the information related to the external illuminance is transmitted to the network through a physical uplink shared channel (PUSCH), and
wherein demodulation reference signals (DM-RSs) of the PUSCH and the SSB are QCL for quasi co-located (QCL) type D.

10. The method of claim 8, further comprising:
transmitting, by the wireless communication unit, the information related to the external illuminance to an artificial intelligence (AI) processor included in the network; and
receiving, by the wireless communication unit, AI processed information from the AI processor,
wherein the AI processed information is information related to a screen brightness setting of the intelligent device.

11. An intelligent device, comprising:
an illuminance sensor configured to sense ambient illuminance of the intelligent device to generate an ambient illuminance value;
a transceiver configured to receive information related to an external illuminance from at least one external device; and
at least one processor configured to select a screen brightness of the intelligent device according to the ambient illuminance value, and adjust the screen brightness of the intelligent device based on the information related to the external illuminance.

12. The intelligent device of claim 11, wherein the information related to the external illuminance comprises at least one of the following:
change time point information of external illuminance associated with the intelligent device,
lighting illumination information associated with at least one light unit providing illumination in an environment of the intelligent device, and
television illumination information associated with a smart television provided in the environment of the intelligent device.

13. The intelligent device of claim 12, wherein the at least one processor is configured to:
determine a plurality of locations of the intelligent device, and
generate a reference illuminance value of the ambient illuminance value according to each of the plurality of locations of the intelligent device, and set an indoor mode or an outdoor mode for the intelligent device based on the generated reference illuminance value.

14. The intelligent device of claim 11, wherein the at least one external device comprises at least one of the following:
a lighting device having at least one lighting unit; and
a smart television, and
wherein a value of the external illuminance comprises at least one of the following.
an illuminance value of a lighting sensed in the lighting device; and
a television illuminance value sensed in the smart television.

15. The intelligent device of claim 14, wherein the at least one processor is configured to:
control the screen brightness of the intelligent device based on the ambient illuminance value while the intelligent device is switched from a turn-off state to a turn-on state, and
control the screen brightness of the intelligent device based on a value of the external illuminance while the turn-on state of the intelligent device is maintained.

16. The intelligent device of claim 11, wherein the at least one processor is configured to:
extract a feature value from the information related to the external illuminance,
input the feature value to a pre-learned deep learning model, and
obtain information related to the screen brightness of the intelligent device based on an output of the deep learning model having the feature value input thereto.

17. The intelligent device of claim 16, wherein the at least one processor is configured to control to gradually change the screen brightness of the intelligent device, when the ambient illuminance of the intelligent device is changed while the intelligent device is being operated.

18. The intelligent device of claim 11, wherein the at least one processor is configured to:
receive, via the transceiver from a network, downlink control information (DCI) used for scheduling transmission of the information related to the external illuminance, and
transmit, via the transceiver, the information related to the external illuminance to the network based on the DC1.

19. The intelligent device of claim 18, wherein the at least one processor is configured to perform an initial access procedure with the network based on a synchronization signal block (SSB),
wherein the information related to the external illuminance is transmitted to the network through a physical uplink shared channel (PUSCH), and
wherein demodulation reference signals (DM-RSs) of the PUSCH and the SSB are QCL for quasi co-located (QCL) type D.

20. The intelligent device of claim 18, wherein the at least one processor is configured to:
control the transceiver to transmit the information related to the external illuminance to an artificial intelligence (AI) processor included in the network, and
control the transceiver to receive AI processed information from the AI processor,
wherein the AI processed information is information related to a screen brightness setting of the intelligent device.
